(19) United States
(12) Patent Application Publication
(10) Pub. No.: US 2007/0300171 A1
(43) Pub. Date: Dec. 27, 2007

(54) Multicurrency display

(75) Inventor: Balaji Hariharan, Hyderbad (IN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/503,347

(22) Filed: Aug. 11, 2006

(30) Foreign Application Priority Data
Jun. 26, 2006 (IN) 1496/DEL/2006

(51) Int. Cl. G06F 3/048

(52) U.S. Cl. 715/764

(57) ABSTRACT

A computer-implemented method of providing information to a user is disclosed. The method includes providing a user interface that includes a data element containing a first numeric value. An input is received from the user and represents a selection of the data element. The input is responded to by displaying a second numeric value that is related to but different than the first numeric value. A determination is made as to when the selection of the data element has ended. Upon that determination, display of the second numeric value is terminated.

The present application claims priority of a patent application in India filed Jun. 26, 2006 and bearing serial number 1496/DEL/2006, the content of which is hereby incorporated by reference in its entirety.

### BACKGROUND

Many computer applications incorporate a user interface configured to display currency values. For example, within a business application, currency values are often displayed in the context of modules for supporting a specific business function such as purchasing or accounting. Of course, not all applications are configured to display values in the context of the same currency system. For example, one application might be configured to display values so as to be consistent with the United States dollar, while another application might be configured for the Japanese yen. In some cases, a user may be able to select one currency unit from a plurality of choices, wherein the display is conformed to the selected currency unit.

Current trends indicate that the world's economies are becoming increasingly integrated. For at least this reason, there are more and more reasons for individuals to be interested in knowing values in the context of more than one currency system. For example, a business operator may be interested in calculating how a discount in his or her “home” currency (e.g., the currency in which a user maintains his own accounts) will translate into one or more “foreign” currencies (e.g., a currency in which external transactions occur). In many cases, these types of translations between currency systems must be manually derived, often times with reliance on multiple applications or devices (e.g., with reliance on one or more business applications and a calculator device or application). For these and many other reasons, there is an increasing need for computer applications that support an efficient and effective multi-currency display.

The discussion above is merely provided for general background information and is not intended for use as an aid in determining the scope of the claimed subject matter. Further, it should also be emphasized that the claimed subject matter is not limited to implementations that solve any disadvantage, or fulfill any specific purpose, noted in this section.

### SUMMARY

A computer-implemented method of providing information to a user is disclosed. The method includes providing a user interface that includes a data element containing a first numeric value. An input is received from the user and represents a selection of the data element. The input is responded to by displaying a second numeric value that is related to but different than the first numeric value. A determination is made as to when the selection of the data element has ended. Upon that determination, display of the second numeric value is terminated.

This Summary is provided to introduce a selection of concepts in a simplified form that are further described below in the Detailed Description. This Summary is not intended to identify key features or essential features of the claimed subject matter, nor is it intended for use as an aid in determining the scope of the claimed subject matter.

### BRIEF DESCRIPTION OF THE DRAWINGS

FIG. 1 is a block diagram of one computing environment in which some embodiments may be practiced.

FIG. 2 is a block flow diagram demonstrating a method of displaying data.

FIGS. 3A-3D are diagrammatic illustrations of a portion of a user interface 300.

### DETAILED DESCRIPTION

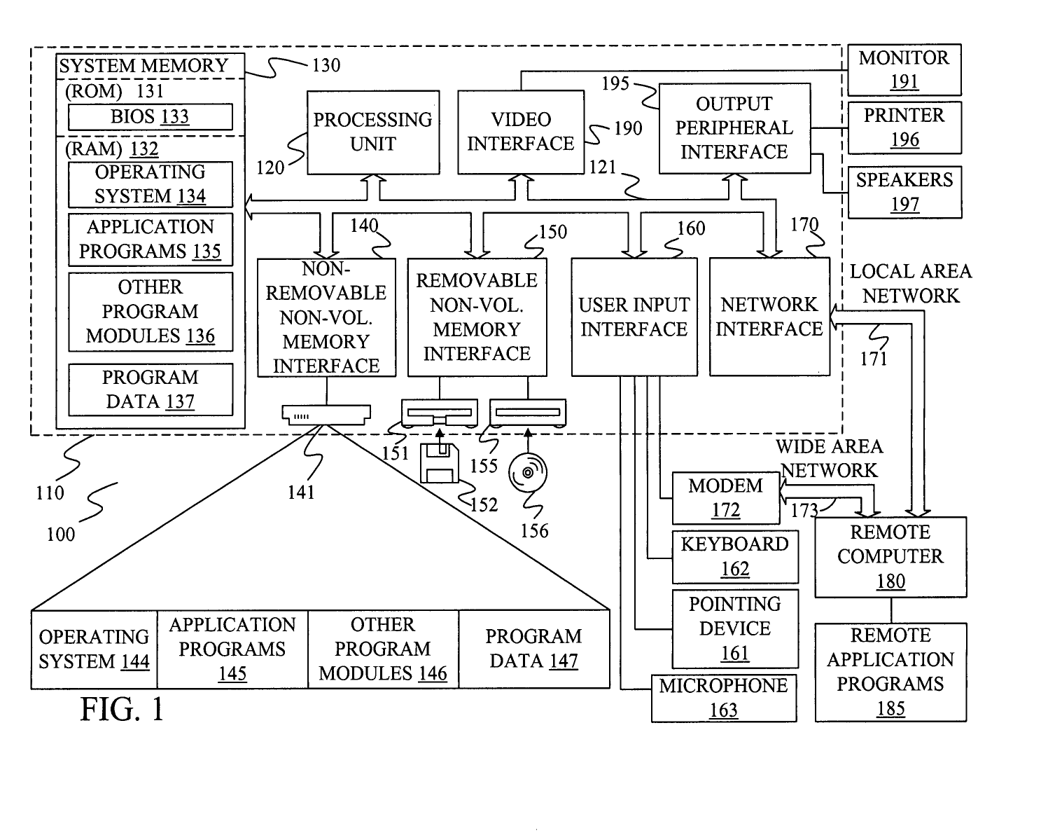

FIG. 1 illustrates an example of a suitable computing system environment 100 on which embodiments may be implemented. The computing system environment 100 is only one example of a suitable computing environment and is not intended to suggest any limitation as to the scope of use or functionality of the claimed subject matter. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

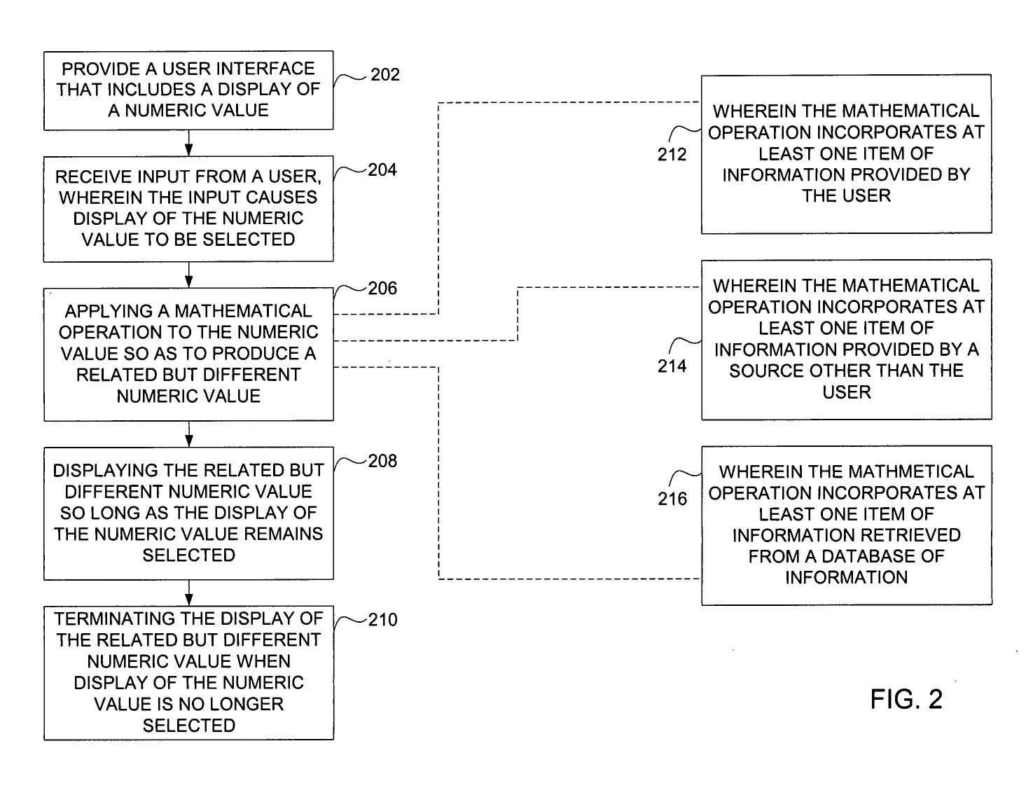

FIG. 2 is a block flow diagram demonstrating a method of displaying data. The method can be implemented in the context of an environment such as that described in relation to FIG. 1. Of course, those skilled in the art will appreciate the present invention also contemplates the application of same or similar methods in other environments as well.

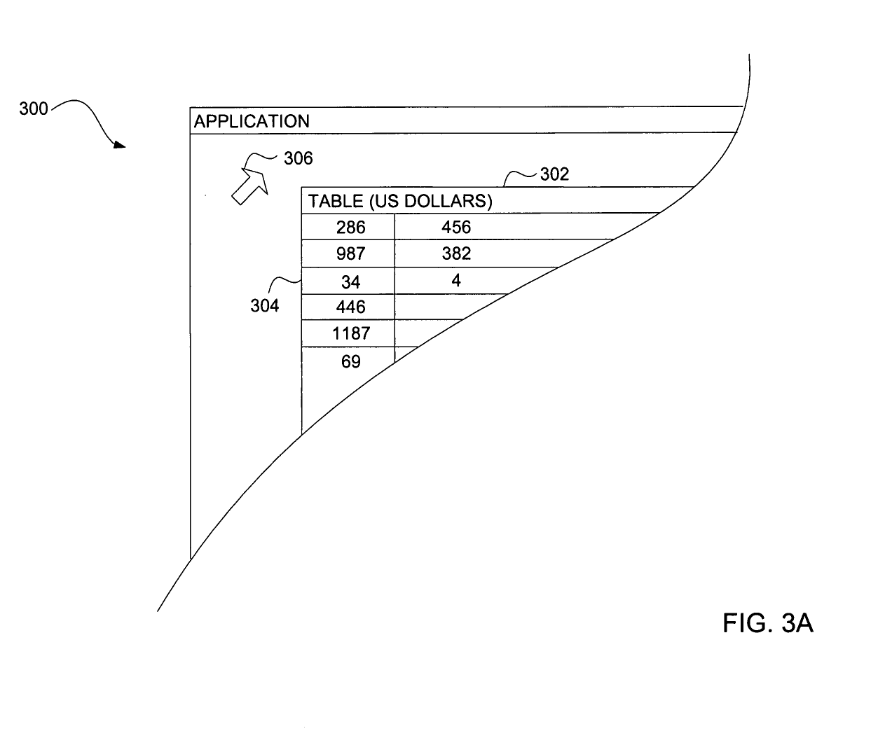

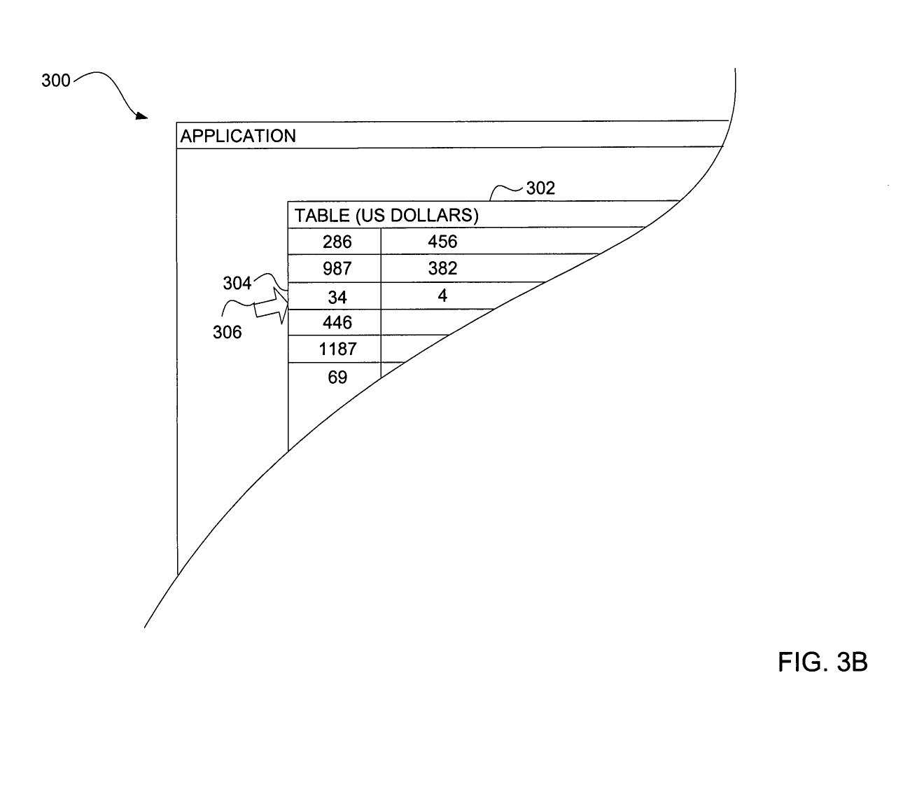

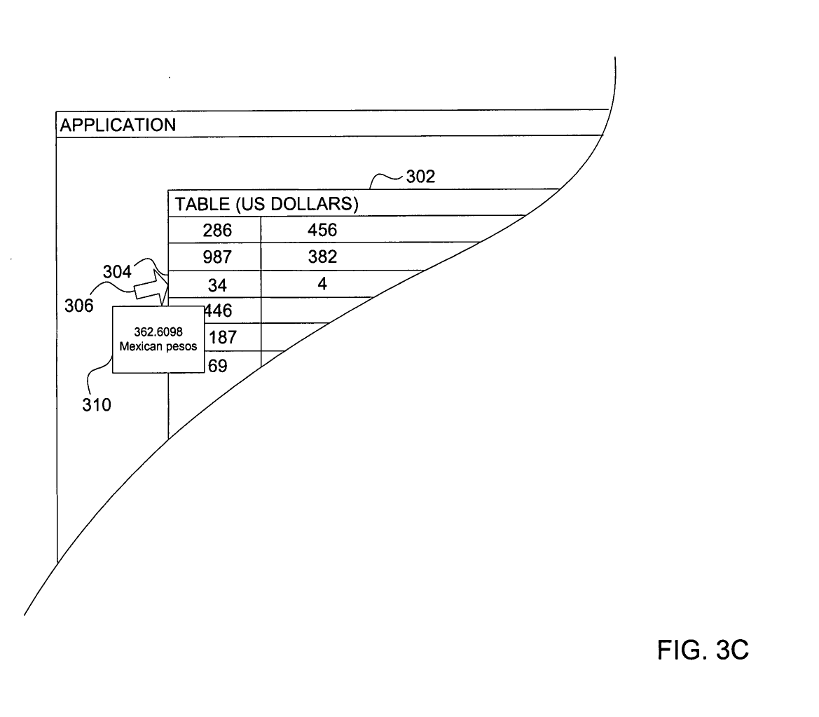

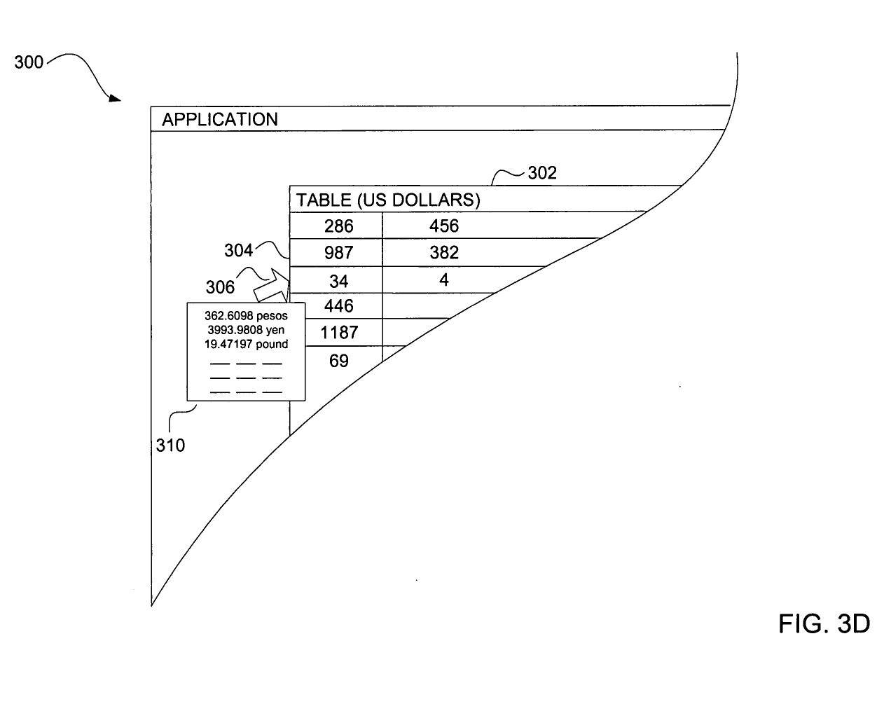

FIGS. 3A-3D are diagrammatic illustrations of a portion of a user interface 300. These Figures are intended to provide an example of how the method of FIG. 2 might be implemented. Of course, the scope of the present invention is not limited to the precise implementation illustrated in FIGS. 3A-3D. Those skilled in the art will appreciate that the illustrated implementation is but one of many potential implementations to be considered within the scope of the present invention.

In accordance with block 202, a user interface is provided and includes display of a numeric value. Referring to FIG. 3A, user interface 300 includes a display of a table 302. Table 302 includes multiple data elements containing numeric values, one of which has been designated within the Figure as item 304. A cursor element 306 is shown within user interface 300 in a position outside of table 302. As is well known in the art, a user is illustratively able to manipulate the positioning of cursor 306 by asserting commands through input devices such as, but not limited to, those device described specifically in the description of FIG. 1.

In accordance with block 204, a user causes the numeric value to be selected. For example, the user causes a cursor element to be located in a position that is visually indicative of the numeric value. As is shown in FIG. 3B, cursor element 306 has been re-positioned such that it now indicates data element 304.

Those skilled in the art will appreciate that different systems might have different standards for determining something is indicated. For example, one system might require a cursor element to overlap its target, while another system might only require adjacent or proximate positioning. Further, the cursor element need not necessarily have the appearance of an arrow. For example, it could just as easily have the appearance of a pointing finger or any other indicator. Still further, means other than a cursor could just as easily be employed to similarly provide an indication. All such alternatives are to be considered within the scope of the present invention.

In accordance with block 206, a mathematical operation is applied to the numeric value associated with the indicated data element. In this manner a related but different numeric value is derived. In accordance with block 208, the related but different numeric value is displayed so long as the data element associated with the numeric value remains selected (e.g., visually indicated by the cursor element).

With reference to FIG. 3C, the “34” shown within data element 304 illustratively represents a value in accordance with U.S. dollars. A mathematical operator is illustratively applied by the system to determine that 34 U.S. dollars is equivalent to 362.6098 Mexican Pesos. A pop-up box 310 is then generated in order to display the result of the conversion calculation to the user. As is generally indicated by block 210, pop-up block 310 illustratively remains displayed at least until cursor element 306 is moved out of its indicative relationship to data element 304. The user is able of course to move the cursor to indicate other displayed data elements in order to generate and display similar visual indications of currency equivalence.

The precise manner of display of a related but different value can be made contingent upon predetermined action of the selection mechanism. For example, timing restrictions can be employed to support intuitive and/or visually appealing implementation of the described display features. In one embodiment, the system can be configured such that generation and display of an equivalence pop-up box for a selected data element only occurs after the cursor element remains in a selection-oriented position for a predetermined period of time. This prevents an over-taxing of system resources, for example, as a cursor is quickly moved across multiple data elements. In one embodiment, termination of the display of a currency equivalence pop-up box can be similarly contingent upon timing characteristics.

In one embodiment, the system can be configured to display multiple related but different numerical values in a single pop-up box. For example, within FIG. 3D, equivalent values are shown in box 310 in the form of Mexican pesos, the Japanese yen and the English pound. A system can illustratively be configured to default to displaying certain currencies or certain information. In one embodiment, however, a user can selectively configure what information is generated and displayed.

It is to be understood that conversions other than determinations of currency equivalence are to be considered within the scope of the present invention. In one embodiment, a user can select or input the mathematical operation to be applied. For example, the user might configure the pop-up box mechanism to display a 23% discount below the displayed values. The mathematical operation could potentially be quite complex or simple.

In one embodiment, the conversions incorporate dependence upon one or more outside parameters. In accordance with block 212, the system can be configured to support acquisition of such a parameter directly from the user. In accordance with block 214, the system can be configured to support acquisition of such a parameter from a source other than the user. In accordance with block 216, the system can be configured to support acquisition of such a parameter from a database of information (e.g., a local database, a database accessed over a computer network, a database accessed over the Internet, etc.).

Currency conversions are a good example of a conversion that may be made dependent upon one or more outside parameters. Currency conversions may be made dependent upon one or more desired or applicable exchange rates. The exchange rate information that is incorporated into the derivation of the related but different currency representation is illustratively provided to the system directly from user, or from a source other than the user (e.g., a business manager), or from a remote or local database.

In one embodiment, the system is configured to calculate on the fly a value displayed in a pop-up box as described. In other words, the calculation is performed only after the user has communicated a request through his or her input behavior. In another embodiment, however, at least calculation is made in anticipation of a request and cached for subsequent retrieval after the actual request is communicated.

An application configured to support a user interface similar to that shown in relation to FIGS. 3A-3D is illustratively multi-currency enabled at least in that it is configured to display a “home” currency in conjunction with a “foreign” currency. The described selection-based display scheme, which is similar to a tool-tip display scheme, avoids the alternative of more persistent display of such data. In doing so, significant display clutter and potential user confusion are avoided. Further, it eliminates any necessity for a user to access a separate application or device in order to determine a particular currency equivalent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of providing information to a user, the method comprising:
providing a user interface that includes a data element containing a first numeric value;
receiving an input from the user, wherein the input represents a selection of the data element;
responding to the input by displaying a second numeric value that is related to but different than the first numeric value;
determining that the selection of the data element has ended; and
terminating display of the second numeric value.

2. The method of claim 1, wherein determining that the selection of the data element has ended comprises receiving further input from the user, wherein the further input is indicative that the selection of the data element has ended.

3. The method of claim 1, further comprising generating the second numeric value by applying a mathematical operation to the first numeric value.

4. The method of claim 3, wherein applying a mathematical operation comprises converting based on a currency exchange rate.

5. The method of claim 3, wherein applying a mathematical operation comprises converting based on a provided a numeric parameter.

6. The method of claim 3, wherein applying a mathematical operation comprises converting based on a numeric parameter obtained from the user.

7. The method of claim 3, wherein applying a mathematical operation comprises converting based on a numeric parameter obtained from a source other than the user.

8. The method of claim 3, wherein applying a mathematical operation comprises converting based on a numeric parameter obtained from a database.

9. The method of claim 3, wherein applying a mathematical operation comprises converting based on a numeric parameter obtained from a remotely accessed database.

10. The method of claim 1, wherein displaying a second numeric value comprises displaying the first numeric value as converted into at least one different system of currency.

11. The method of claim 1, wherein receiving an input comprises receiving an input that includes information related to cursor placement.

12. The method of claim 1, wherein displaying a second numeric value comprises displaying a pop-up box.

13. The method of claim 1, wherein the first numeric value is consistent with a first system of currency and the second numeric value represents the first numeric value as translated into a system of currency other than the first system.

14. The method of claim 1, wherein responding to the input further comprises displaying multiple numeric values that are related to but different than the first numeric value.

15. A computer-implemented method of providing a user with multicurrency information, the method comprising:
displaying a first numeric value that represents a quantity based on a first system of currency; and
temporarily displaying a second numeric value that represents the first numeric value as converted into a different system of currency, wherein temporarily displaying comprises making the time of display contingent upon selection input received from the user.

16. The method of claim 15, wherein the second numeric value is determined by applying a mathematical operation that incorporates at least one item of information provided by the user.

17. The method of claim 15, wherein the second numeric value is determined by applying a mathematical operation that incorporates at least one item of information provided by a source other than the user.

18. The method of claim 15, wherein the second numeric value is determined by applying a mathematical operation that incorporates at least one item of information retrieved from a database.

19. A computer-implemented user interface, comprising:
a data element containing a first numeric value;
an input means for selecting the data element;
a system component configured to display a second numeric value that is related to but different to the first numeric value, wherein how long the second numeric value is displayed is contingent upon at least one selection characteristic related to the input means.

20. The user interface of claim 19, wherein the second numeric value is determined by applying a mathematical operation that incorporates conversion based on a currency exchange rate.
